(19) United States
(12) Patent Application Publication
(10) Pub. No.: US 2026/0058522 A1
(43) Pub. Date: Feb. 26, 2026

(54) ELECTRIC WORK MACHINE

(71) Applicant: MAKITA CORPORATION, Anjo-shi (JP)

(72) Inventors: Yusuke ICHIOKA, Anjo-shi (JP); Yoshimasa FUKUOKA, Anjo-shi (JP)

(73) Assignee: MAKITA CORPORATION, Anjo-shi (JP)

(21) Appl. No.: 19/297,666

(22) Filed: Aug. 12, 2025

(30) Foreign Application Priority Data
Aug. 22, 2024 (JP) 2024-141042

(51) Int. Cl. H02K 7/14; B27B 17/08; H02K 1/2791; H02K 3/32; H02K 3/34; H02K 3/52; H02K 11/215; H02K 11/33

(52) U.S. Cl. CPC H02K 7/145; B27B 17/08; H02K 1/2791; H02K 3/325; H02K 3/522; H02K 11/215; H02K 3/345; H02K 11/33

(57) ABSTRACT

An electric work machine includes a stator, a working portion, a stator base, and an insulating member. The stator includes coils. Each of the coils includes a wire. The stator base supports the stator from an inner side thereof. The insulating member is disposed between the stator base and the wire.

### CROSS-REFERENCE TO RELATED APPLICATIONS

This application claims the benefit of Japanese Patent Application No. 2024-141042 filed on Aug. 22, 2024 with the Japanese Patent Office, the entire disclosure of which is incorporated herein by reference.

### BACKGROUND

The present disclosure relates to an electric work machine that includes an outer rotor motor.

An electric work machine disclosed in Japanese Unexamined Patent Application Publication 2023-005814 includes an outer rotor motor as its power source. The outer rotor motor includes a stator that is fixed to a stator base, and a rotor that rotates outside the stator.

The stator includes a stator core that includes two or more teeth, and a coil wound around each of the two or more teeth via an insulator. A wiring including a lead wire that is drawn out from the coil is disposed between the stator and the stator base.

### SUMMARY

If the aforementioned wiring comes in contact with the stator base when the motor is driven, a short circuit occurs in the motor. Thus, in the aforementioned motor, an insulating distance is secured between the wiring and the stator base by widening the space between the stator and the stator base. However, if the space between the stator and the stator base is widened, the size of the motor increases in a direction along its rotational axis. Consequently, there has been a problem that it is difficult to reduce the size of the electric work machine.

In one aspect of the present disclosure, it is desirable, in the electric work machine that includes the outer rotor motor, to inhibit an increase in the size of the motor while securing the insulating distance between the stator base and the wiring, which is disposed between the stator and the stator base.

The electric work machine in one aspect of the present disclosure includes a stator, a rotor, a working portion, a stator base, and an insulating member.

The stator includes a stator core, an insulator, and coils. The stator core includes a cylindrical yoke, and two or more teeth each protruding outwards from the yoke in radial directions. The insulator is fixed to the stator core. Each of the coils includes a wire, a part of which is wound around a corresponding one of the two or more teeth via the insulator.

The rotor includes a rotor core and a magnet and rotates about a rotational shaft. The rotor core is disposed on an outer circumferential side of the stator. The magnet is fixed to the rotor core.

The working portion is driven by the rotor. The stator base supports the stator from an inner side thereof. The insulating member is disposed between the stator base and the wire.

The stator and the rotor of the aforementioned electric work machine function as the outer rotor type motor. In the aforementioned electric work machine, the wire disposed between the stator and the stator base may approach the stator base, for example, when the coil comes loose. However, due to the insulating member being disposed between the stator base and the wire, the wire is inhibited from coming into contact with the stator base. Thus, in the aforementioned electric work machine, it is possible to inhibit the size of the motor, and thus the size of the electric work machine, from increasing while securing the insulating distance between the wire and the stator base.

### BRIEF DESCRIPTION OF THE DRAWINGS

Example embodiments of the present disclosure will be described hereinafter with reference to the accompanying drawings, in which:

FIG. 1 is a perspective view showing an external appearance of an electric work machine of a first embodiment;

FIG. 2 is a perspective view showing a motor and a controller inside the electric work machine of the first embodiment seen from above;

FIG. 3 is an exploded perspective view of the motor shown in FIG. 2;

FIG. 4 is a perspective view showing the motor shown in FIG. 2 seen from below;

FIG. 5 is an exploded perspective view of the motor shown in FIG. 4;

FIG. 6 is a cross-sectional view showing the motor shown in FIG. 2 cut along a rotational shaft;

FIG. 7 is a wiring diagram showing a state of connection between coils of the motor of the first embodiment and the controller;

FIG. 8A is an explanatory diagram showing a configuration of an insulating member of a motor of a second embodiment and is a side view of the insulating member;

FIG. 8B is an explanatory diagram showing a configuration of the insulating member of the motor of the second embodiment and is a perspective view of the insulating member seen obliquely from above;

FIG. 8C is an explanatory diagram showing a configuration of the insulating member of the motor of the second embodiment and is a perspective view of the insulating member seen obliquely from below;

FIG. 9 is a side view of the motor of the second embodiment;

FIG. 10 is a perspective view of the motor shown in FIG. 9 seen from above; and

FIG. 11 is a perspective view of the motor shown in FIG. 9 seen from below.

### DETAILED DESCRIPTION OF EXEMPLARY EMBODIMENTS

### Overview of Embodiments

An embodiment may provide an electric work machine that includes at least any one of the following features.
Feature 1: a stator.
Feature 2: the stator includes a stator core.
Feature 3: the stator core includes a cylindrical yoke.
Feature 4: the stator core includes two or more teeth each of which protrudes outwards from the yoke in radial directions.
Feature 5: the stator includes an insulator.
Feature 6: the insulator is fixed to the stator core.
Feature 7: the stator includes coils.
Feature 8: each of the coils includes a wire.
Feature 9: a part of the wire is wound around a corresponding one of the two or more teeth via the insulator.
Feature 10: a rotor that rotates about a rotational shaft.
Feature 11: the rotor includes a rotor core disposed on an outer circumferential side of the stator.
Feature 12: the rotor includes a magnet that is fixed to the rotor core.
Feature 13: a working portion driven by the rotor.
Feature 14: a stator base that supports the stator from an inner side thereof.
Feature 15: an insulating member disposed between the stator base and the wire.

In the electric work machine that includes at least Features 1 through 15, the wiring disposed between the stator and the stator base may approach the stator base, for example, when the wire of a coil comes loose. However, due to the insulating member being disposed between the stator base and the wire, the wire is inhibited from coming into contact with the stator base. Thus, it is possible to reduce the size of the motor, and thus the size of the electric work machine, while securing an insulating distance between the wire and the stator base.

In one embodiment, the electric work machine may include the following feature in addition to or in place of at least any one of Features 1 through 15.
Feature 16: the insulating member is fixed to the stator base.

In the electric work machine that includes at least Features 1 through 16, the insulating distance between the wire and the stator base can be stably secured due to the insulating member being fixed to the stator base.

In one embodiment, the electric work machine may include the following features in addition to or in place of at least any one of Features 1 through 16.
Feature 17: the stator includes a wiring.
Feature 18: the insulating member includes a guiding portion configured to guide the wiring in a given direction.

In the electric work machine that includes at least Features 1 through 15, and 17 through 18, the wiring is guided by the guiding portion and drawn out in the given direction. Thus, it is possible to more preferably inhibit the wiring from vibrating and coming into contact with the stator base during operation.

In one embodiment, the electric work machine may include the following features in addition to or in place of at least any one of Features 1 through 18.
Feature 19: the wiring includes lead wires that are coupled to the coils.
Feature 20: the guiding portion guides at least the lead wires in the given direction.

In the electric work machine that includes at least Features 1 through 15, and 17 through 20, the guiding portion can inhibit the lead wires from vibrating and coming into contact with the stator base during operation.

In one embodiment, the electric work machine may include the following features in addition to or in place of at least any one of Features 1 through 20.
Feature 21: the stator includes phases.
Feature 22: the lead wires are bundled for each phase of the stator.
Feature 23: a bundle of the lead wires includes a fusing terminal at an end thereof.

In the electric work machine that includes at least Features 1 through 15, and 17 through 23, the lead wires are bundled for each phase of the stator, and therefore it is possible to more preferably inhibit the lead wires from coming into contact with the stator base. It is also possible to couple each coil to the controller via the lead wires and the fusing terminal.

In one embodiment, the electric work machine may include the following features in addition to or in place of at least any one of Features 1 through 23.
Feature 24: the stator includes three phases.
Feature 25: at least one coil of each phase of the stator are coupled to each other in a delta configuration via the fusing terminal.

In the electric work machine that includes at least Features 1 through 15, and 17 through 25, at least one coil of each phase of the stator are coupled to each other in a delta configuration, and therefore, a wiring at the midpoint as required in a star configuration is not necessary. Thus, it is possible to easily couple the coils of the stator to the controller.

In one embodiment, the electric work machine may include the following features in addition to or in place of at least any one of Features 1 through 25.
Feature 26: the yoke includes a first hollow.
Feature 27: the stator base includes a supporting portion that has a cylindrical shape and that is inserted through the first hollow.
Feature 28: the insulating member has a disk-like shape and includes a second hollow through which the supporting portion is insertable.

In the electric work machine that includes at least Features 1 through 15, and 26 through 28, it is possible to fix the insulating member between the stator base and the stator by inserting the supporting portion of the stator through the hollow in the yoke while the insulating member is inserted through the supporting portion of the stator base. Accordingly, it is possible to fix the insulating member easily and robustly.

In one embodiment, the electric work machine may include the following feature in addition to or in place of at least any one of Features 1 through 28.
Feature 29: the guiding portion is disposed to protrude from a peripheral edge of the insulating member.

In the electric work machine that includes at least Features 1 through 15, 17 through 18, and 26 through 29, the guiding portion is disposed to protrude from the peripheral edge of the insulating member. Thus, it is possible to inhibit the guiding portion from interfering with the fixing of the insulating member when the insulating member is fixed between the stator base and the stator.

In one embodiment, the electric work machine may include the following feature in addition to or in place of at least any one of Features 1 through 29.
Feature 30: the guiding portion includes a gap through which the wiring is insertable.

In the electric work machine that includes at least Features 1 through 15, 17 through 18, and 26 through 30, it is possible to insert the wiring, which includes the lead wires, through the gap between the insulating member and the guiding portion and draw the wiring out from the gap. Consequently, it is possible to draw the wiring out to a desired direction by the guiding portion.

In one embodiment, the electric work machine may include the following feature in addition to or in place of at least any one of Features 1 through 30.
Feature 31: the wiring is inserted through the gap from a side where the stator is situated toward an opposite side.

In the electric work machine that includes at least Features 1 through 15, 17 through 18, and 26 through 31, the wiring is inserted through the gap from the side where the stator is situated. Thus, it is possible to facilitate inserting work of the wiring. Consequently, it is possible to increase efficiency of assembling the insulating member and the stator to the stator base.

In one embodiment, the electric work machine may include the following feature in addition to or in place of at least any one of Features 1 through 31.
Feature 32: the wiring is drawn out from the insulating member toward the outside of the stator in the radial direction.

In the electric work machine that includes at least Features 1 through 15, 17 through 18, and 32, the wiring, which includes the lead wires, is drawn out toward the outside of the stator in the radial direction. Thus, it is possible to more preferably inhibit the drawn wiring from coming into contact with the stator base.

In one embodiment, the electric work machine may include the following features in addition to or in place of at least any one of Features 1 through 32.
Feature 33: a magnetic sensor that is mounted on the stator base and that detects a rotational position of the rotor based on magnetic flux from the magnet.
Feature 34: a signal line coupled to the magnetic sensor.
Feature 35: the insulating member inhibits at least the signal line from coming into contact with the rotor.

In the electric work machine that includes at least Features 1 through 15, and 33 through 35, the insulating member inhibits the signal line from coming into contact with the rotor. Thus, it is possible to increase reliability of motor control of the electric work machine using the magnetic sensor.

In one embodiment, the electric work machine may include the following features in addition to or in place of at least any one of Features 1 through 35.
Feature 36: a circuit board mounted on the stator base.
Feature 37: the magnetic sensor is installed on the circuit board.
Feature 38: the signal line is coupled to the magnetic sensor via the circuit board.

In the electric work machine that includes at least Features 1 through 15, 33 through 38, the signal line is coupled to the magnetic sensor via the circuit board. Thus, it is possible to more preferably inhibit the signal line from swinging near the magnetic sensor and coming into contact with the rotor.

In one embodiment, the electric work machine may include the following features in addition to or in place of at least any one of Features 1 through 38.
Feature 39: the insulating member includes a protector.
Feature 40: the protector faces a portion of the rotor between the rotor core and an outer circumferential end portion.
Feature 41: the protector has a fixed length along an outer circumference of the rotor.
Feature 42: the protector includes a plate surface.
Feature 43: the insulating member includes a holder that retains the plate surface at a given position between the stator base and the rotor core.

In the electric work machine that includes at least Features 1 through 15, and 33 through 43, it is possible to more preferably inhibit the signal line from the magnetic sensor from coming into contact with the rotor by the protector of the insulating member.

An embodiment may provide a method that includes at least any one of the following features. This method is a method of manufacturing a motor that is installed in an electric work machine.
Feature 44: fixing a stator of the motor to a stator base that supports the stator from an inner side thereof.
Feature 45: disposing an insulating member between the stator base and coils of the stator.

According to the method that includes at least Features 44 through 45, the insulating member is disposed between the stator base and the coils. This inhibits the wire of the coils from coming into contact with the stator base. Accordingly, it is possible to inhibit the size of the motor, and thus the size of the electric work machine, from increasing while securing the insulating distance between the wiring and the stator base.

Examples of the aforementioned electric work machine include machinery configured to be used in a work site of construction, manufacturing, gardening, civil engineering, and the like; and more specifically, a power tool for stone processing, metal processing, or wood processing, a power tool for gardening, and a battery-operated wheel barrow. Examples of the aforementioned power tool include an electric blower, an electric hammer, an electric hammer drill, an electric drill, an electric screwdriver, an electric wrench, an electric grinder, an electric circular saw, an electric reciprocating saw, an electric jigsaw, an electric cutter, an electric chainsaw, an electric planer, an electric nailer (including a tacker), an electric hedge trimmer, an electric lawn mower, an electric lawn trimmer, an electric grass cutter, an electric cleaner, an electric sprayer, an electric spreader, an electric dust collector, an electric trowel, an electric vibrator, an electric rammer, an electric compactor, an electric pump, an electric pile driver, an electric concrete saw, an electric screed, an electric cut-off saw, and the like.

In one embodiment, the aforementioned Features 1 through 45 may be combined in any manner.

In one embodiment, any one or more of the aforementioned Features 1 through 45 may be excluded.

### SPECIFIC EXAMPLE EMBODIMENTS

Hereinafter, specific example embodiments will be explained. These specific example embodiments provide an electric work machine 1 in a form of an electric chain saw. The electric chain saw is a kind of a gardening tool. However, such electric work machine 1 is merely an example and thus the present disclosure can be implemented in any form of electric work machines.

### First Embodiment

### <Electric Work Machine>

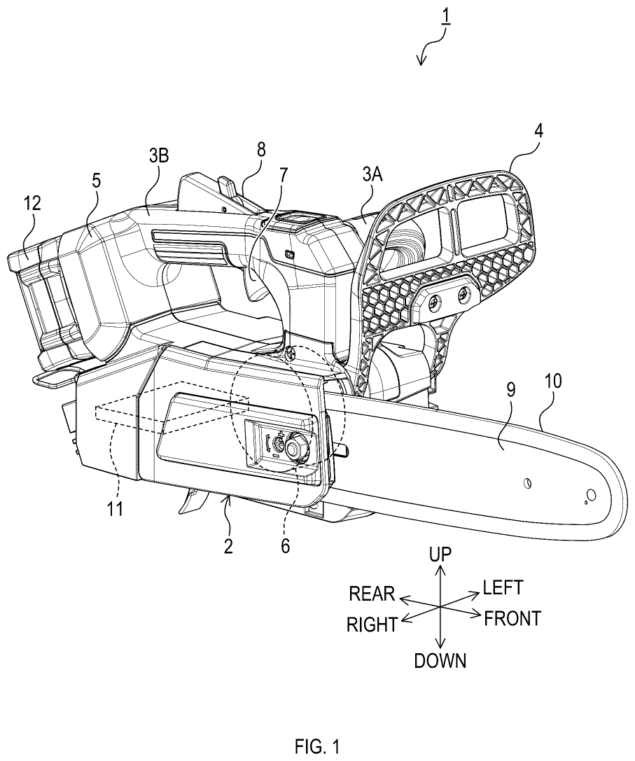

The electric work machine 1 of the first embodiment will be explained with reference to FIG. 1. The electric work machine 1 includes a housing 2. The housing 2 is made of a synthetic resin. The housing 2 houses a motor 6 therein. The housing 2 houses a controller 11 therein.

The electric work machine 1 includes a guide bar 9. The guide bar 9 is a plate-like member. The guide bar 9 protrudes from the housing 2 towards the front of the electric work machine 1.

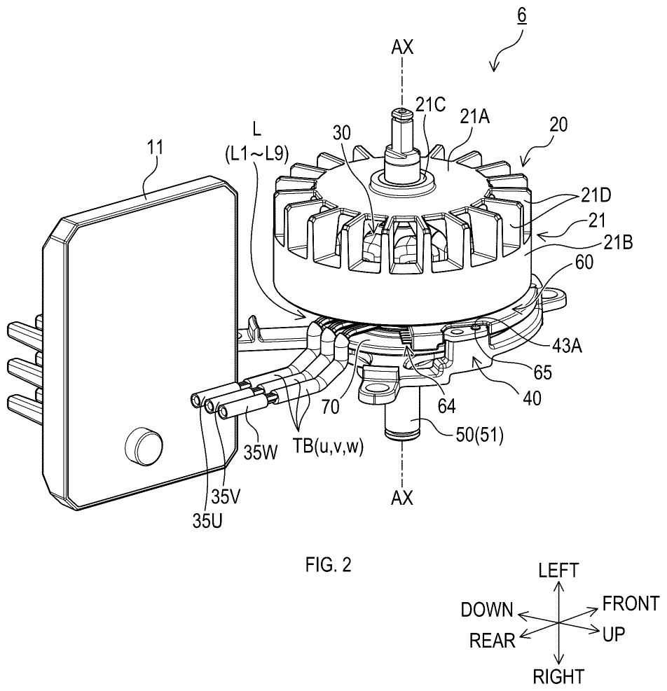

The electric work machine 1 includes a saw chain 10, which is a working portion of the electric work machine 1. The saw chain 10 includes cutters that are coupled to each other. The saw chain 10 is detachably attached to a peripheral portion of the guide bar 9. The saw chain 10 is coupled to a rotor shaft 50 (see FIG. 2) of the motor 6 via a power transmission mechanism (not illustrated). The power transmission mechanism includes a sprocket (not illustrated) that is configured to allow the saw chain 10 to be attached thereto.

Thus, the saw chain 10 moves on the peripheral portion of the guide bar 9 as the motor 6 is driven. The electric work machine 1 can cut a workpiece with the moving saw chain 10.

The electric work machine 1 includes a battery port 5. The battery port 5 protrudes upwards from a rear portion of the housing 2. A battery pack 12 is detachably attached to the battery port 5. The battery pack 12 can be attached to a rear end surface of the battery port 5. The battery pack 12 includes a rechargeable battery, for example, a chargeable/dischargeable lithium ion battery. The battery pack 12 can supply power to the electric work machine 1 by being attached to the battery port 5. The motor 6 receives power from the battery pack 12 via the controller 11 and is driven thereby.

The electric work machine 1 includes a hand guard 4. The hand guard 4 protrudes upwards from a front portion of the housing 2.

The electric work machine 1 includes a side handle 3A and a top handle 3B at the rear of the hand guard 4. The side handle 3A or the top handle 3B may be omitted. The side handle 3A and the top handle 3B are made of a synthetic resin.

The side handle 3A is a pipe-like member. The side handle 3A protrudes from a left portion of the housing 2 toward the left. Thus, an operator of the electric work machine 1 can hold the side handle 3A from the rear of the electric work machine 1 with his/her left hand.

The top handle 3B protrudes upward from a top portion of the housing 2. A rear end of the top handle 3B is coupled to the battery port 5, which creates a space between the top handle 3B and the housing 2. Thus, the operator can hold the top handle 3B by inserting his/her fingers in this space.

The electric work machine 1 includes a trigger switch 7 on a bottom surface of the top handle 3B. The trigger switch 7 is operated (pulled, for example) by the operator to drive the motor 6. In response to the trigger switch 7 being pulled upward by the operator, the motor 6 is driven. In response to the operation of the trigger switch 7 being released, the drive of the motor 6 is stopped.

The electric work machine 1 includes a trigger lock lever 8 on a top surface of the top handle 3B. In response to the trigger lock lever 8 being pushed downward, the operation of the trigger switch 7 is enabled.

### <Motor>

In the present embodiment, the motor 6 is in a form of an outer rotor type brushless motor.

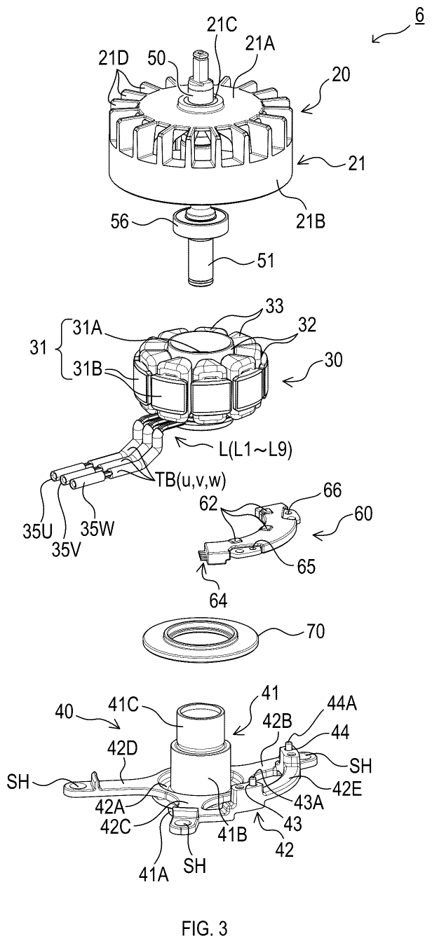

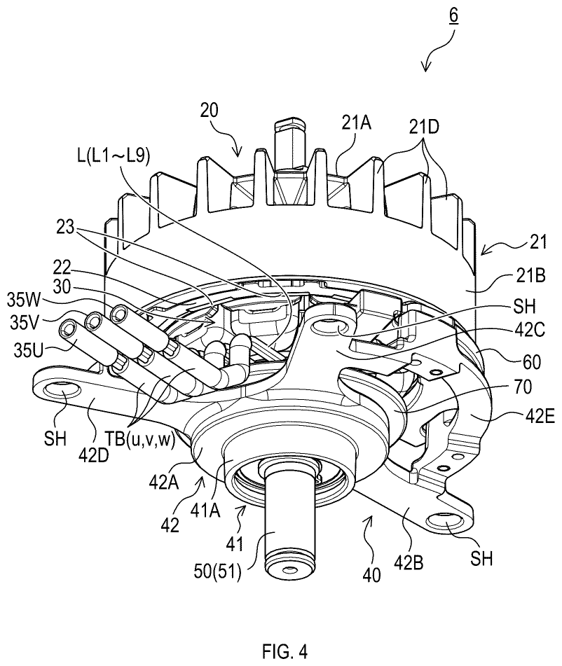

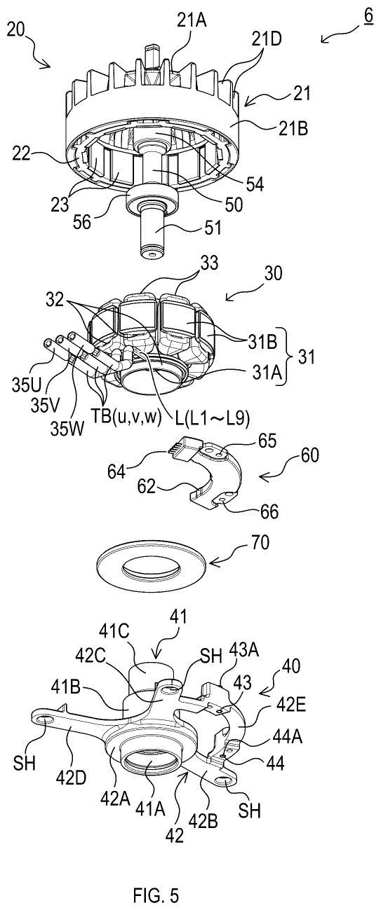

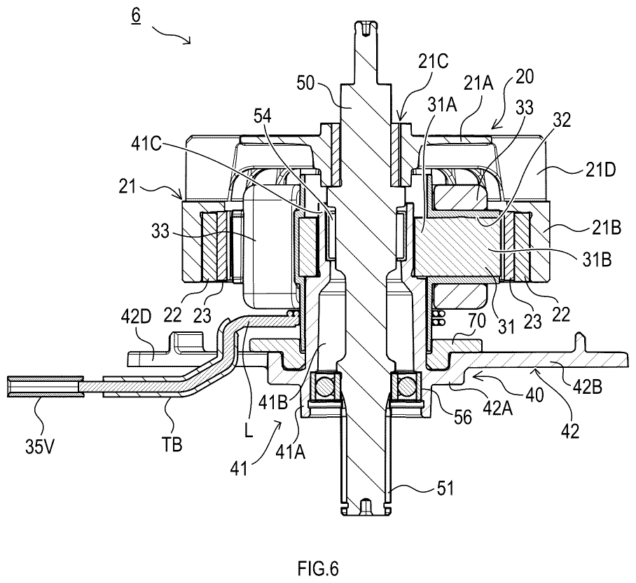

As shown in FIG. 2, FIG. 3, FIG. 4, FIG. 5, and FIG. 6, the motor 6 includes a rotor 20. The motor 6 includes a stator 30.

The rotor 20 is disposed in an outside of an outer circumferential surface of the stator 30 and rotates around the stator 30.

The motor 6 includes the rotor shaft 50. The rotor shaft 50 is fixed to the rotor 20. An central axis of the rotor shaft 50 coincides with a rotational shaft AX of the motor 6. Thus, the rotor 20 and the rotor shaft 50 rotate about the rotational shaft AX.

The motor 6 includes a sensor board 60. The sensor board 60 includes three magnetic sensors 62 (Hall sensors, for example) that detect a rotational position of the rotor 20.

The motor 6 includes a stator base 40. The stator base 40 supports the stator 30 and the sensor board 60.

The motor 6 includes an insulating member 70. The insulating member 70 is disposed between the stator base 40 and the stator 30.

The rotor shaft 50 protrudes from the rotor 20 to the outside through the stator 30, the insulating member 70, and the stator base 40. The rotor shaft 50 includes an output shaft 51. The output shaft 51 is a part of the rotor shaft 50 and includes an end that protrudes from the stator base 40 to the outside. The output shaft 51 is coupled to the power transmission mechanism. The rotor shaft 50 moves the saw chain 10 via the power transmission mechanism.

### <Rotor>

The rotor 20 includes a rotor cup 21. The rotor cup 21 is made of metal. Specifically, the rotor cup 21 contains aluminum, which is a non-magnetic body, as its main component.

The rotor cup 21 includes a plate portion 21A. The plate portion 21A has an annular shape. The plate portion 21A includes an aperture 21C in its central portion. The aperture 21C allows the rotor shaft 50 to pass therethrough and fixes the rotor shaft 50. The rotor shaft 50 may be fixed to the rotor cup 21 in any manner. In the present embodiment, the rotor shaft 50 is press-fitted into the aperture 21C and thereby fixed to the aperture 21C (and thus to the rotor cup 21).

The rotor cup 21 includes a yoke portion 21B. The yoke portion 21B has a cylindrical shape. The yoke portion 21B surrounds the rotor shaft 50.

The rotor cup 21 includes fins 21D between the plate portion 21A and the yoke portion 21B. The yoke portion 21B is coupled to a peripheral edge of the plate portion 21A via the fins 21D. The fins 21D is arranged along an outer circumference of the plate portion 21A at equal intervals. The fins 21D rotate with the plate portion 21A (in other words, with the rotor 20) and thereby generate wind. Thus generated wind cools the motor 6.

The rotor 20 includes a rotor core 22. The rotor core 22 includes steel plates that are laminated on one another in a direction along the rotational shaft AX (hereinafter referred to as “axial direction”). The rotor core 22 has a substantially cylindrical shape. The rotor core 22 is supported by an inner circumferential surface of the yoke portion 21B of the rotor cup 21.

The rotor 20 includes magnets 23. Each of the magnets 23 is a permanent magnet. Each of the magnets 23 has a plate-like shape. Each of the magnets 23 is a sintered magnet in the present embodiment. The magnets 23 are arranged at intervals on an inner circumferential surface of the rotor core 22 in a circumferential direction. The magnets 23 are each fixed to the inner circumferential surface of the rotor core 22 with, for example, an adhesive. In the present embodiment, the magnets 23 include 12 (twelve) magnets 23, for example. The magnets 23 are arranged on the inner circumferential surface of the rotor core 22 in the circumferential direction such that the north pole and the south pole appear alternately.

### <Stator>

The stator 30 includes a stator core 31. The stator core 31 includes steel plates laminated in the axial direction. The stator core 31 includes a yoke 31 A. The yoke 31 A has a cylindrical shape. The yoke 31 A is disposed around the rotor shaft 50 via the stator base 40. A central axis of the yoke 31 A coincides with the rotational shaft AX.

The stator core 31 includes teeth 31B. The teeth 31B protrudes outward from an outer circumferential surface of the yoke 31 A in the radial direction. The teeth 31B are arranged at intervals in the circumferential direction. In the present embodiment, the teeth 31B includes 9 (nine) teeth 31B. A slot is formed between two teeth 31B that are arranged next to each other.

The stator 30 includes an insulator 32. The insulator 32 is made of a synthetic resin for example. The insulator 32 at least partially covers a surface of the stator core 31.

The stator 30 includes coils 33. Each of the coils 33 includes a wire CW. Specifically, the insulator 32 covers a coil-attaching surface of each of the teeth 31B and the outer circumferential surface of the yoke 31 A. The wire CW of a corresponding one of the coils 33 is wound around the coil-attaching surface. The wire CW of each of the coils 33 contacts the outer circumferential surface of the yoke 31 A. The stator core 31 is insulated from the coils 33 by the insulator 32.

In the present embodiment, the stator core 31 and the insulator 32 are integrally formed. The insulator 32 may be fixed to the stator core 31 by insert molding. Specifically, the stator core 31 and the insulator 32 may be formed as described below. Firstly, the stator core 31 is housed in a mold. Then, heat-melted synthetic resin is injected into the mold. The synthetic resin is solidified and thereby the stator core 31 and the insulator 32 are integrated; in other words, the insulator 32 is fixed to the stator core 31.

The stator 30 includes the aforementioned coils 33. Each of the coils 33 are disposed on a corresponding one of the teeth 31B. In other words, in the present embodiment, the coils 33 includes 9 (nine) coils 33. The wire CW of each of the coils 33 is wound around a corresponding one of the teeth 31B. Accordingly, the number of the coils 33 corresponds to the number of the teeth 31B (9 (nine) in the present embodiment). In each of the teeth 31B, the coil-attaching surface is covered by the insulator 32, however, an outer circumferential surface of the tooth is not covered by the insulator 32. The outer circumferential surface of the tooth is a surface that faces radially outside.

### <Bearing>

The motor 6 includes bearings. The bearings (i) allows the rotor shaft 50 to pass therethrough and (ii) rotatably supports the rotor shaft 50 (and thus the rotor 20).

In the present embodiment, the bearings include a first bearing 54 and a second bearing 56. The first bearing 54 is fitted into a third supporting portion 41 C of the stator base 40 which will be mentioned below. The second bearing 56 is fitted into a first supporting portion 41 A of the stator base 40 which will be mentioned below.

In the present embodiment, the first bearing 54 is in a form of a roller bearing (specifically, a radial roller bearing; more specifically, a needle roller bearing), and the second bearing 56 is in a form of a ball bearing (specifically, a radial ball bearing).

### <Stator Base>

The stator base 40 in the present embodiment is made of aluminum. In the present embodiment, the stator base 40 is integrally formed.

The stator base 40 includes a supporting portion 41. The supporting portion 41 (i) has a cylindrical shape and (ii) has different levels along the rotational shaft AX. Specifically, the supporting portion 41 includes the first supporting portion 41A, a second supporting portion 41B, and a third supporting portion 41C. The first supporting portion 41A, the second supporting portion 41B, and the third supporting portion 41C all have a cylindrical shape but different outer diameters. The first supporting portion 41A extends along the rotational shaft AX and is coupled to the second supporting portion 41B. The second supporting portion 41B extends along the rotational shaft AX and is coupled to the third supporting portion 41C. An outer diameter of the second supporting portion 41B is larger than an outer diameter of the third supporting portion 41C. An outer diameter of the first supporting portion 41A is larger than the outer diameter of the second supporting portion 41B.

The first supporting portion 41A has an inner diameter that allows the second bearing 56 to be fitted therein. The outer diameter of the second supporting portion 41B can be fitted into a hollow of the insulator 32 and is larger than an inner diameter of a hollow 311 of the stator core 31 (specifically, a hollow 311 of a yoke 31). The third supporting portion 41C has an inner diameter that allows the first bearing 54 to be fitted therein, and the outer diameter of the third supporting portion 41C can be fitted into the hollow 311 of the stator core 31.

FIG. 3 and FIG. 5 show a state where the rotor shaft 50 is inserted through the first bearing 54 and the second bearing 56. However, actually, the first bearing 54 and the second bearing 56 are first fixed to the stator base 40 as mentioned below. Then, the rotor shaft 50 is inserted into the stator base 40 and thereby supported by the first bearing 54 and the second bearing 56.

The first bearing 54 and the second bearing 56 may each be fixed to the stator base 40 in any manner. In the present embodiment, the first bearing 54 is press-fitted into the third supporting portion 41C. In other words, the first bearing 54 is fixed to the third supporting portion 41C by a press-fitting method. In the present embodiment, the second bearing 56 is also press-fitted into the first supporting portion 41A. However, the first bearing 54 may be fixed to the third supporting portion 41C by a method different from the press-fitting method. The same applies to the second bearing 56.

The third supporting portion 41C is fitted into the yoke 31A and thereby the stator base 40 supports the stator core 31 from an inner side of the stator core 31. The first bearing 54 is disposed such that it at least partially overlap the stator core 31 and the rotor core 22 in the axial direction. The second bearing 56 does not overlap the stator core 31 and the rotor core 22 in the axial direction.

When assembling the motor 6, the first bearing 54 and the second bearing 56 are fixed to the stator base 40. Then, the rotor shaft 50 is inserted into the stator 30, the insulating member 70, and the stator base 40 in this order, and thereby the rotor shaft 50 is supported by the stator base 40 (specifically by the first bearing 54 and the second bearing 56). Accordingly, the output shaft 51 of the motor 6 is supported by the first supporting portion 41A so as to be rotatable about the rotational shaft AX.

The stator base 40 includes a fixing portion 42. The fixing portion 42 is integrally formed with the supporting portion 41. The fixing portion 42 includes a fixing portion main body 42A. The fixing portion main body 42A has a shape of a hollow disk. The fixing portion main body 42A is disposed around an outer circumferential surface of the first supporting portion 41A.

The fixing portion 42 includes a first fixing portion 42B, a second fixing portion 42C, and a third fixing portion 42D. Any one or two of the first fixing portion 42B, the second fixing portion 42C, and the third fixing portion 42D may be omitted.

Each of the first fixing portion 42B, the second fixing portion 42C, and the third fixing portion 42D protrudes outward from the fixing portion main body 42A in the radial directions. A screw hole SH is formed at an edge portion of each of the first fixing portion 42B, the second fixing portion 42C, and the third fixing portion 42D. The edge portion is positioned on the opposite side to the fixing portion main body 42A. A screw that is not illustrated is inserted into each of the screw hole SH. The motor 6 is fixed inside the housing 2 with the screw inserted into each of the three screw holes SH.

A board fixing portion 42E is disposed between the first fixing portion 42B and the second fixing portion 42C. The board fixing portion 42E fixes the sensor board 60. The board fixing portion 42E has a shape that corresponds to the shape of the sensor board 60, specifically an arc shape formed about the rotational shaft AX.

As shown in FIG. 3 and FIG. 5, the board fixing portion 42E includes a first hole 43 and a first pin 43A in its first end. The first pin 43A is inserted into the first hole 43. Specifically, in the present embodiment, the first pin 43A is press-fitted into the first hole 43.

The board fixing portion 42E includes a second hole 44 and a second pin 44A on its second end. The second pin 44A is inserted into the second hole 44. Specifically, in the present embodiment, the second pin 44A is press-fitted into the second hole 44.

The first pin 43A is inserted into a third hole 65 of the sensor board 60. The second pin 44A is inserted into a fourth hole 66 of the sensor board 60. FIG. 2 shows a state where the first pin 43A is inserted into the third hole 65. In the present embodiment, the first pin 43A and the second pin 44A are respectively fitted to the third hole 65 and the fourth hole 66 by clearance fitting. The first pin 43A and the second pin 44A allow the sensor board 60 to be positioned at a given position with respect to the stator base 40 (and thus with respect to the stator 30).

### <Sensor Board>

The sensor board 60 includes the third hole 65 and the fourth hole 66 mentioned above. The sensor board 60 includes three magnetic sensors 62 that detects a rotational position of the rotor 20. Each of the three magnetic sensors 62 detects a change in a magnetic field that is caused in association with a rotation of the rotor 20 and outputs a detection signal that corresponds to the detected change. The sensor board 60 is supported by the stator base 40 such that each of the three magnetic sensors 62 installed on the sensor board 60 faces a corresponding one of the magnets 23 in the axial directions. The sensor board 60 is disposed radially outside the coils 33.

### <Insulating Member>

The insulating member 70 is made of a synthetic resin. The insulating member 70 has a shape of a hollow disk. An inner hole (that is, a hollow) 711 of the insulating member 70 has an inner diameter that allows the second supporting portion 41B to be inserted therethrough. An outer diameter of the insulating member 70 corresponds to (that is, equal to or close to) an outer diameter of an virtual circle surrounding an outer circumference of the coils 33. Thus, if the stator 30 is viewed from the fixing portion 42 of the stator base 40 in the axial direction, most of or all of the coils 33 are hidden by the insulating member 70 and thus cannot be seen.

### EFFECTS

Due to the insulating member 70 being configured as mentioned above, it is possible to secure an insulating distance between a stator wiring group and the stator base 40. The stator wiring group includes the wire CW of each of the coils 33 and/or a lead wire drawn from each of the coils 33.

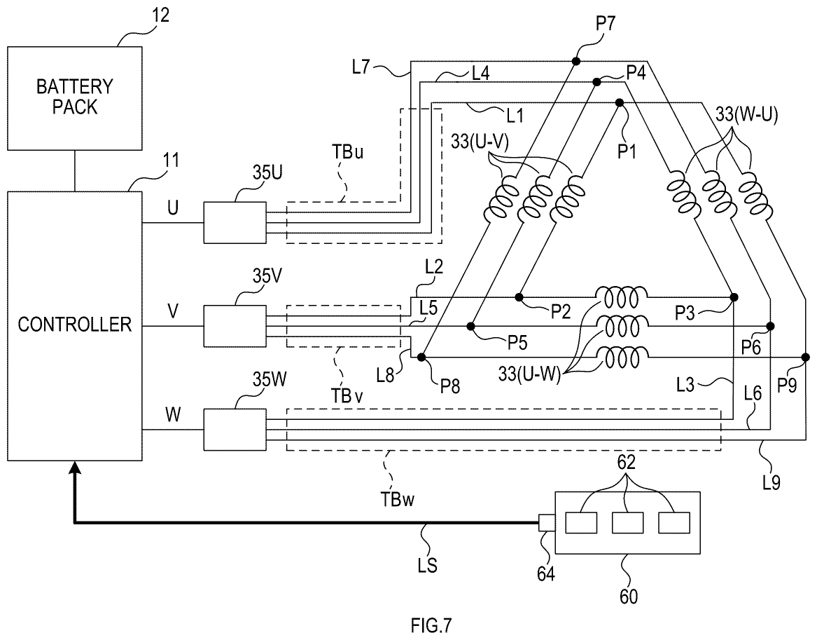

In other words, in the present embodiment, nine coils 33 are coupled to each other in a delta configuration. Specifically, for example, two coils 33 that are disposed next to each other in the circumferential direction are coupled to each other. More specifically, as shown in FIG. 7, the motor 6 includes a first to a ninth connection points P1 to P9. Each of the first to the ninth connection points P1 to P9 corresponds to the connection point of the two coils 33 that are disposed next to each other. The first, the fourth, and the seventh connection points P1, P4 and P7 correspond to a U-phase. The second, the fifth, and the eighth connection points P2, P5 and P8 correspond to a V-phase. The third, the sixth and the ninth connection points P3, P6 and P9 correspond to a W-phase.

The motor 6 includes a lead wire group L. The lead wire group L in the present embodiment includes a first to a ninth lead wires L1 to L9. Each of the first to the ninth lead wires L1 to L9 is flexible.

The first connection point P1 is coupled to a first end of the first lead wire L1. The second connection point P2 is coupled to a first end of the second lead wire L2. The third connection point P3 is coupled to a first end of the third lead wire L3. The fourth connection point P4 is coupled to a first end of the fourth lead wire L4. The fifth connection point P5 is coupled to a first end of the fifth lead wire L5. The sixth connection point P6 is coupled to a first end of the sixth lead wire L6. The seventh connection point P7 is coupled to a first end of the seventh lead wire L7. The eighth connection point P8 is coupled to a first end of the eighth lead wire L8. The ninth connection point P9 is coupled to a first end of the ninth lead wire L9.

As shown in FIG. 2 to FIG. 7, the motor 6 includes a first fusing terminal 35U, a second fusing terminal 35V, a third fusing terminal 35W, a first tube TBu, a second tube TBv, and a third tube TBw.

As shown in FIG. 7, a second end of the first lead wire L1, a second end of the fourth lead wire L4, and a second end of the seventh lead wire L7 are coupled to the first fusing terminal 35U. The first fusing terminal 35U corresponds to the U-phase.

A second end of the second lead wire L2, a second end of the fifth lead wire L5, and a second end of the eighth lead wire L8 are coupled to the second fusing terminal 35V. The second fusing terminal 35V corresponds to the V-phase.

A second end of the third lead wire L3, a second end of the sixth lead wire L6, and a second end of the ninth lead wire L9 are coupled to the third fusing terminal 35W. The third fusing terminal 35W corresponds to the W-phase.

The first, the fourth, and the seventh lead wires L1, L4, and L7 are bundled together and inserted through the first tube TBu that corresponds to the U-phase.

The second, the fifth, and the eighth lead wires L2, L5, and L8 are bundled together and inserted through the second tube TBv that corresponds to the V-phase.

The third, the sixth, and the ninth lead wires L3, L6, and L9 are bundled together and inserted through the third tube TBw that corresponds to the W-phase.

As a consequence, as shown in FIG. 5, the stator wiring group is concentratedly disposed (i) between the stator 30 and the stator base 40 and (ii) around the yoke 31A. The stator wiring group includes the wire CW of each of the coils 33 and/or the first to the ninth lead wires L1 to L9.

Accordingly, in a case where the motor 6 does not include the insulating member 70, it is necessary to increase the distance between the stator 30 and the stator base 40 in the axial direction in order to secure the insulating distance between the stator wiring group and the stator base 40. However, in this case, the motor 6 is elongated in the axial direction which causes an increase in the size of the motor 6.

Meanwhile, in the present embodiment, it is possible to secure the insulating distance between the stator wiring group and the stator base 40 by the insulating member 70. Thus, the distance between the stator 30 and the stator base 40 can be reduced which makes it possible to reduce the size of the motor 6.

### Second Embodiment

The basic configuration of the electric work machine 1 of the present embodiment is the same as the electric work machine described in the first embodiment. The difference between the present embodiment and the first embodiment is the configuration of the insulating member 70. Thus, in the present embodiment, the configuration and function of the insulating member 70 will be described in detail.

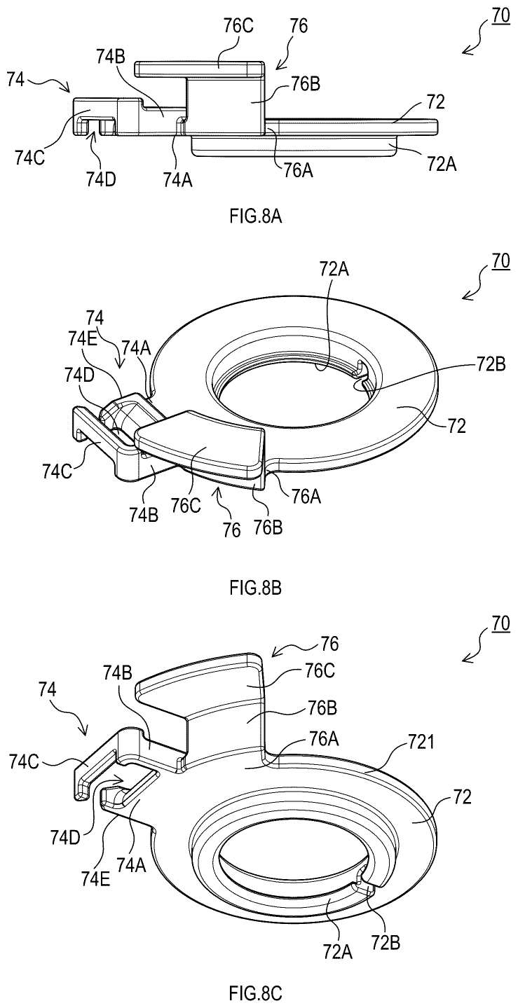

As shown in FIG. 8A, FIG. 8B, and FIG. 8C, the insulating member 70 includes a main body 72, a guiding portion 74, and an insulation protection portion 76.

The main body 72 has a shape of a hollow disk similarly to the insulating member 70 of the first embodiment. The main body 72 includes a protrusion 72A. The protrusion 72A protrudes from a plate surface of the main body 72 having an annular shape toward the fixing portion 42 of the stator base 40. The protrusion 72A has an annular shape, and a part of the protrusion 72A includes a cutout 72B. An inner diameter of the protrusion 72A is the same as an inner diameter of the main body 72. The protrusion 72A is fitted into a groove (not illustrated) formed in the fixing portion main body 42A of the stator base 40. The cutout 72B engages with a protrusion formed on this groove. Thus, a position of the insulating member 70 with respect to the rotational shaft AX of the motor 6 in the circumferential direction is fixed.

The guiding portion 74 includes an extending portion 74A that extends radially outward from the main body 72 of the insulating member 70. The extending portion 74A has a given width along a peripheral edge 721 of the main body 72 of the insulating member 70, and a plate thickness of an edge portion of the extending portion 74A is greater than a plate thickness of the main body 72. The edge portion of the extending portion 74A slopes downward from a side where the stator 30 is disposed toward the opposite side such that a length extended from the main body 72 increases.

The extending portion 74A includes a first protrusion 74B and a second protrusion 74E. The first protrusion 74B protrudes radially outside the insulating member 70 from a first end of the extending portion 74A in circumferential direction. The second protrusion 74E protrudes radially outside the insulating member 70 from a second end of the extending portion 74A in the circumferential directions. The first protrusion 74B includes an engaging portion 74C on its end portion. The engaging portion 74C extends in the circumferential direction. A gap 74D is formed between the extending portion 74A and the engaging portion 74C.

This gap 74D has a width in the radial directions that allows at least one of the aforementioned first to third tubes TBu to TBw to pass therethrough. The gap 74D has a length in the circumferential directions that allows the first to the third tubes TBu to TBw, which are arranged next to each other along the peripheral edge 721 of the main body 72, to pass therethrough.

As a consequence, the first to the third tubes TBu to TBw can be inserted through the gap 74D by creating a space between the second protrusion 74E and the engaging portion 74C.

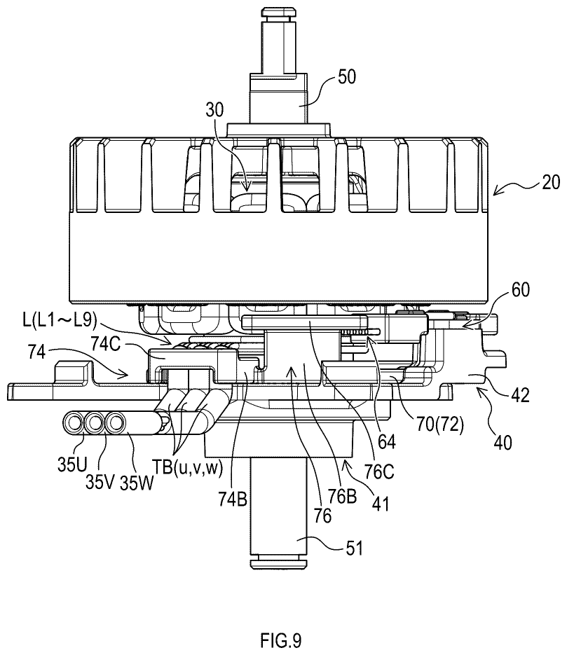

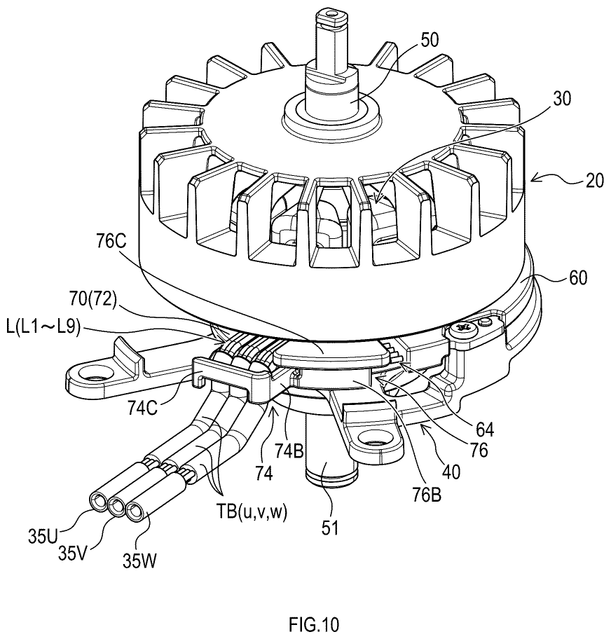

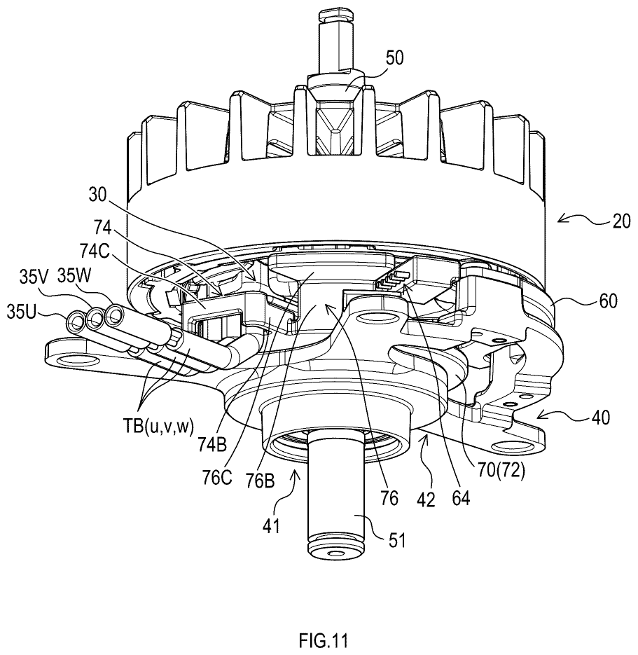

In the present embodiment, as shown in FIG. 9, FIG. 10, and FIG. 11, the aforementioned first to ninth lead wires L1 to L9 are inserted through the gap 74D from the side where the stator 30 is disposed to the opposite side (that is, the opposite side is where the stator base 40 is disposed). Thus inserted first to ninth lead wires L1 to L9 are drawn out from the guiding portion 74 to the outside of the stator 30 in the radial directions together with the first to the third tubes TBu to TBw.

As mentioned above, according to the electric work machine 1 of the present embodiment, the first to the ninth lead wires L1 to L9 of the motor 6 can be drawn out by using the guiding portion 74 disposed in the insulating member 70. Thus, it is possible to more preferably inhibit the first to the ninth lead wires L1 to L9 from coming into contact with the stator base 40. Since the positions of the first to the ninth lead wires L1 to L9 are determined by the gap 74D of the guiding portion 74, it is also possible to inhibit the stator wiring group including the wires CW of the coils 33 from becoming loose. In the guiding portion 74, a wall surface that faces the gap 74D of the extending portion 74A slopes in a direction where the first to the ninth lead wires L1 to L9 are drawn out. This facilitates drawing of the first to the ninth lead wires L1 to L9.

The insulation protection portion 76 inhibits a signal line LS, which couples a connection terminal 64 disposed on the sensor board 60 to the controller 11, from coming into contact with the rotor 20.

The sensor board 60 is a circuit board that includes a conductive trace, which couples the three magnetic sensors 62 mounted on the sensor board 60 to the connection terminal 64. As shown in FIG. 9 to FIG. 11, the connection terminal 64 protrudes at one end of the arc of the sensor board 60. The signal line LS is coupled to this protruding connection terminal 64 as shown in FIG. 7.

This signal line LS is drawn out from the sensor board 60 toward the controller 11 and coupled to the controller 11. Thus, there is a possibility that the signal line LS approaches the rotor 20 due to the orientation or vibration of the electric work machine 1. The insulation protection portion 76 inhibits the signal line LS from coming into contact with the rotor 20 due to the rotation of the rotor 20 when the signal line LS approaches the rotor 20.

As shown in FIG. 8A, FIG. 8B, and FIG. 8C, the insulation protection portion 76 includes an extending portion 76A that extends radially outward from the main body 72 of the insulating member 70. The extending portion 76A extends to a position facing the rotor core 22 in a direction along the rotational shaft AX of the motor 6. The extending portion 76A has a predetermined width along the peripheral edge 721 of the main body 72 of the insulating member 70. The extending portion 76A is disposed next to the extending portion 74A of the guiding portion 74.

The insulation protection portion 76 includes a bent portion 76B. The bent portion 76B is coupled to an extending edge portion of the extending portion 76A so as to bent toward the rotor 20. In a direction along the rotational shaft AX of the motor 6, the bent portion 76B is disposed at a position that is higher than the connection terminal 64 of the sensor board 60. Thus, the bent portion 76B is disposed more closely to the rotor 20 than the connection terminal 64 of the sensor board 60 is.

The insulation protection portion 76 includes a protector 76C. The protector 76C is coupled to an edge portion of the bent portion 76B in a height direction so as to bent toward the outside of the rotor 20 in the radial direction. Due to such an arrangement, the protector 76C inhibits the signal line LS from coming into contact with the rotor 20. A length of the protector 76C in the radial directions is designed so that an edge of the protector 76C in its bending direction coincides with an outer circumferential surface of the rotor cup 21.

Thus, the protector 76C is a plate-like member that faces a portion of the rotor 20 between the rotor core 66 and the outer circumferential end portion, and that has a fixed length along the outer circumference of the rotor 20. The bent portion 76B functions as a holder that retains a plate surface of the protector 76C at a position having a predetermined height between the stator base 40 and the rotor core 22.

Accordingly, the signal line LS that is coupled to the connection terminal 64 of the sensor board 60 is inhibited from coming into contact with the rotor 20 by the bent portion 76B and the protector 76C of the insulation protection portion 76 even in a case where the signal line LS approaches the rotor 20 due to the orientation and vibration of the electric work machine 1. Thus, according to the electric work machine 1 of the present embodiment, it is possible to inhibit the signal line LS that is drawn out from the sensor board 60 from coming into contact with the rotor 20 and being caught into the rotor 20.

### OTHER EMBODIMENTS

Although the embodiments of the present disclosure have been explained above, the present disclosure can be implemented in various modifications without being limited to the aforementioned embodiment.

For example, while the insulating member 70 may be made of an insulating material such as a synthetic resin having an insulation property, the insulating member 70 may also be made by applying an insulating coating material on and around a metallic main body portion, for example.

In the second embodiment, it has been described that the insulating member 70 is prepared by integrating the guiding portion 74 and the insulation protection portion 76 into the main body 72 having a shape of a hollow disk. However, it is not always necessary to form the insulating member 70 to have a shape of a hollow disk, and it is only required that the insulating member 70 can be fixed to the stator base 40. In addition, the insulating member 70 may only include a function as the guiding portion 74 or a function as the insulation protection portion 76.

Two or more functions of one element in the aforementioned embodiments may be achieved by two or more elements, and one function of one element may be achieved by two or more elements. In addition, two or more functions of two or more elements may be achieved by one element, and one function of two or more elements may be achieved by one element. A part of the configurations in the aforementioned embodiments may be omitted. Furthermore, at least a part of the configurations of the aforementioned embodiments may be added to or replaced with another part of the configurations of the aforementioned embodiments.

What is claimed is:

1. An electric work machine comprising:
a stator including a stator core, an insulator, coils, lead wires, and phases;
the stator core including a cylindrical yoke having a first hollow, and two or more teeth each protruding outward from the yoke in radial directions;
the insulator being fixed to the stator core;
each of the coils including a wire, a part of the wire being wound around a corresponding one of the two or more teeth via the insulator; and
the lead wires are coupled to the coils and bundled for each of the phases of the stator;
a rotor including a rotor core and a magnet, the rotor being configured to rotate about a rotational shaft;
the rotor core being disposed on an outer circumferential side of the stator; and
the magnet being fixed to the rotor core;
a working portion configured to be driven by the rotor;
a stator base including a supporting portion that has a cylindrical shape and that is configured to be inserted through the first hollow, and
an insulating member disposed between the stator base and the wire and fixed to the stator base, the insulating member having a disk-like shape and including a second hollow through which the supporting member is insertable.

2. An electric work machine comprising:
a stator including a stator core, an insulator, and coils;
the stator core including a cylindrical yoke and two or more teeth each protruding outward from the yoke in radial directions;
the insulator being fixed to the stator core; and
each of the coils including a wire, a part of the wire being wound around a corresponding one of the two or more teeth via the insulator;
a rotor including a rotor core and a magnet, the rotor being configured to rotate about a rotational shaft;
the rotor core being disposed on an outer circumferential side of the stator; and
the magnet being fixed to the rotor core;
a working portion configured to be driven by the rotor;
a stator base configured to support the stator from an inner side thereof; and
an insulating member disposed between the stator base and the wire.

3. The electric work machine according to claim 2,
wherein the insulating member is fixed to the stator base.

4. The electric work machine according to claim 2,
wherein the stator includes a wiring, and
wherein the insulating member includes a guiding portion configured to guide the wiring in a given direction.

5. The electric work machine according to claim 4,
wherein the wiring includes lead wires coupled to the coils, and
wherein the guiding portion is configured to guide at least the lead wires in the given direction.

6. The electric work machine according to claim 5,
wherein the stator includes phases,
wherein the lead wires are bundled for each phase of the stator, and
wherein a bundle of the lead wires includes a fusing terminal at an end thereof.

7. The electric work machine according to claim 6,
wherein the stator includes three phases, and
wherein at least one coil of each phase of the stator are coupled to each other in a delta configuration via the fusing terminal.

8. The electric work machine according to claim 2,
wherein the yoke includes a first hollow,
wherein the stator base includes a supporting portion that has a cylindrical shape and that is configured to be inserted through the first hollow, and
wherein the insulating member has a disk-like shape and includes a second hollow through which the supporting portion is insertable.

9. The electric work machine according to claim 4,
wherein the yoke includes a first hollow,
wherein the stator base includes a supporting portion that has a cylindrical shape and that is configured to be inserted through the first hollow,
wherein the insulating member has a disk-like shape and includes a second hollow through which the supporting portion is insertable, and
wherein the guiding portion is disposed to protrude from a peripheral edge of the insulating member.

10. The electric work machine according to claim 9,
wherein the guiding portion includes a gap through which the wiring is insertable.

11. The electric work machine according to claim 10,
wherein the wiring is inserted through the gap from a side where the stator is located toward an opposite side.

12. The electric work machine according to claim 4,
wherein the wiring is drawn out from the insulating member toward an outside of the stator in the radial direction.

13. The electric work machine according to claim 2, further comprising:
a magnetic sensor mounted on the stator base and configured to detect a rotational position of the rotor based on magnetic flux from the magnet; and
a signal line coupled to the magnetic sensor,
wherein the insulating member is configured to inhibit at least the signal line from coming into contact with the rotor.

14. The electric work machine according to claim 13, further comprising:
a circuit board mounted on the stator base,
wherein the magnetic sensor is installed on the circuit board, and
wherein the signal line is coupled to the magnetic sensor via the circuit board.

15. The electric work machine according to claim 13,
wherein the insulating member includes:
a protector that faces a portion of the rotor between the rotor core and an outer circumferential end portion, the protector having a fixed length along an outer circumference of the rotor, and the protector including a plate surface; and
a holder configured to retain the plate surface at a given position between the stator base and the rotor core.

16. A method of assembling a motor for an electric work machine, the method comprising:
fixing a stator of the motor to a stator base that supports the stator from an inner side thereof; and
disposing an insulating member between the stator base and coils of the stator.
